(19) United States
(12) Patent Application Publication
(10) Pub. No.: US 2026/0274216 A1
(43) Pub. Date: Sep. 17, 2026

(54) METHOD FOR BRAKING A VEHICLE FOR CARRYING PASSENGERS, CONTROL UNIT, AND VEHICLE FOR CARRYING PASSENGERS

(71) Applicant: ZF CV Systems Global GmbH, Bern (CH)

(72) Inventor: Ellankavi RAMASAMY, Markdorf (DE)

(21) Appl. No.: 19/472,734

(22) PCT Filed: Mar. 20, 2024
(86) PCT No.: PCT/EP2024/057361

§ 371 Date: Oct. 6, 2025

(30) Foreign Application Priority Data
Apr. 14, 2023 (DE) 10 2023 109 400.9

(51) Int. Cl. B60T 7/12

(52) U.S. Cl. CPC B60T 7/12; B60T 2201/022; B60T 2210/32; B60T 2230/04

(57) ABSTRACT

A method for braking a vehicle with passengers, who are standing and/or not strapped in, in an interior of the vehicle, the method including, in the presence of a trigger criterion, braking the vehicle based on a defined brake profile by a braking system. The brake profile has at least one braking phase with a number of chronologically successive partial braking regions. Within the respective partial braking regions, an actual ego deceleration is defined such that, in the braking phase, the vehicle is braked by the actual ego deceleration, which changes over time. The brake profile is defined by detecting road users located in an environment outside the vehicle and detecting passengers located in the interior of the vehicle. The brake profile is further defined by determining road user information associated with the respectively detected road users, and determining passenger information associated with the respectively detected passengers.

### CROSS REFERENCE TO RELATED APPLICATIONS

This application is a U.S. National Phase application under 35 U.S.C. § 371 of International Application No. PCT/EP2024/057361, filed on Mar. 20, 2024, and claims benefit to German Patent Application No. DE 10 2023 109 400. 9 , filed on Apr. 14, 2023. The International Application was published in German on Oct. 17, 2024 as WO 2024/213357 A1 under PCT Article 21(2).

### FIELD

The present invention relates to a method for braking a vehicle for carrying passengers, to a control unit for carrying out the method, and to a vehicle for carrying passengers.

### BACKGROUND

It is known from the prior art to brake vehicles in a cascade consisting of a visual and acoustic warning, a haptic warning in the form of a partial braking operation that can be felt by the strapped-in driver, and a subsequent emergency braking phase. In DE 10 2008 045 481 A1, a certain actual ego deceleration for the vehicle is set during the partial braking operation in the haptic warning phase, wherein the actual ego deceleration increases continuously in time with a certain actual jerk, with the result that there is also a continuously increasing actual ego deceleration for the vehicle. In the emergency braking phase, the vehicle is then braked to a standstill with a constant emergency braking deceleration, wherein the actual ego deceleration increases abruptly between the haptic warning phase and the emergency braking phase. In emergency braking situations, the vehicle can thereby be decelerated efficiently with several warnings to the strapped-in driver and, at the same time, a collision can be avoided or consequences of a collision can be reduced.

EP 2 407 358 B1 furthermore describes that, when a warning condition is present as a trigger criterion for braking the vehicle in the context of emergency braking, first of all brief, jerky braking of the vehicle takes place, wherein the vehicle is braked briefly with a jerk which can be felt by the strapped-in driver owing to the jerky braking. In this case, this serves as a haptic warning to the strapped-in driver before the actual braking phase. Subsequently, the braking phase is initiated, in which the vehicle is braked by means of a braking system, preferably to a standstill, by a setpoint ego deceleration, which varies with respect to time, in the form of two stages in two partial braking regions, in order to avoid a collision.

Further braking methods for avoiding collisions are described in EP 2 388 757 B1 and EP 3 326 874 A1.

For a vehicle in which there are normally passengers who are standing and/or not strapped in, for example a bus, this conventional cascade is not always expedient with regard to the safety of these passengers. Particularly in braking situations for collision avoidance, this cascade must therefore be adapted in a manner appropriate to this situation.

For this purpose, it is disclosed in DE 10 2014 008 431 A1, when there is a probability of a collision, to first warn the driver of a bus visually and/or acoustically and then to brake the bus automatically in a braking phase by setting a velocity-dependent actual ego deceleration, thereby once again alerting the driver to the collision avoidance measure. In this case, an abrupt jump to a velocity-dependent actual ego deceleration perceptible by the driver is made at the beginning of the braking phase. Starting from this, a continuous increase of the actual ego deceleration can then take place up to a maximum deceleration which corresponds to approximately half of an emergency braking deceleration. A subsequent emergency braking phase does not take place in order to avoid endangering the passengers.

It is disadvantageous in known methods that the passengers of the vehicle may fall in the event of an abrupt or sudden rise in the actual ego deceleration since this abrupt rise is matched to a haptic warning to the strapped-in driver and the passengers are often not holding on to the intended holding points and/or are distracted. Thus, if an abrupt increase in the actual ego deceleration is requested in the braking phase in order to warn the strapped-in driver or to bring the vehicle to a standstill as quickly as possible, this can lead to dangerous consequential situations for the passengers.

Therefore, WO 2021/160287 A1 provides for firstly causing a conditioning braking pulse through brief, pulsed braking of the vehicle such that the passengers in the vehicle experience brief, time-limited braking of the vehicle and, immediately after the conditioning braking pulse, a braking phase is initiated in multiple partial braking ranges with a respectively different, decreasing and merging actual jerk. As a result of the conditioning braking pulse, the passengers can be conditioned in a first step, wherein they then tense their muscles and possibly also perform a lunge in order to increase their stability for the subsequent braking phase and possibly also keep themselves more sturdy. In the partial braking regions of the braking phase, a jerky change in the actual ego deceleration and thus excessive staggering by the passengers is prevented.

A disadvantage in the prior art is that the individual phases of braking to a standstill are defined in advance, so that the vehicle is always braked in the same way and with the same brake profile irrespective of the actual braking situation and irrespective of the persons or living beings involved.

### SUMMARY

In an embodiment, the present disclosure provides a method for braking a vehicle with passengers, who are standing and/or not strapped in, in an interior of the vehicle, the method comprising, in the presence of a trigger criterion, braking the vehicle based on a defined brake profile by a braking system. The brake profile has at least one braking phase with a number of chronologically successive partial braking regions. Within the respective partial braking regions, an actual ego deceleration is defined such that, in the braking phase, the vehicle is braked by the actual ego deceleration, which changes over time. The brake profile is defined by detecting road users located in an environment outside the vehicle and detecting passengers located in the interior of the vehicle. The brake profile is further defined by determining road user information which is associated with the respectively detected road users, and determining passenger information which is associated with the respectively detected passengers. The brake profile is further defined by reading in a passenger injury profile for the detected passengers based on the respectively determined passenger information, and reading in a road user injury profile for the detected road users based on the respectively determined road user information. The brake profile is further defined by defining and/or reading out the brake profile based on the passenger injury profiles read in and/or the road user injury profiles read in, such that there is a minimum degree of injury for the detected road users and/or for the detected passengers in the case of the available brake profiles. The brake profile is further defined by outputting the brake profile and actuating the braking system based on the brake profile.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic overview of a vehicle set up to carry out a method according to the present disclosure;

FIG. 2 shows a flow chart of a method according to the present disclosure;

FIGS. 3, 4A, 4B and 4C show exemplary brake profiles; and

FIGS. 5A, 5B and 5C show exemplary degrees of injury.

### DETAILED DESCRIPTION

Embodiments of the present disclosure provide a method, a control unit and a vehicle which can be used to easily achieve a safer braking operation which is more pleasant for people. Embodiments of the present disclosure relate to a method for braking a vehicle for carrying passengers, in particular a road vehicle for carrying passengers who are standing and/or not strapped in, for example a bus, and to a control device and to a vehicle for carrying passengers, in particular a bus.

Accordingly, an embodiment of the present disclosure provides a method for braking a vehicle with passengers in an interior of the vehicle, in particular passengers who are standing and/or not strapped in, wherein, in the presence of a trigger criterion, for example when a determined collision probability of the vehicle with an object is above a predefined limit value, the vehicle is braked by means of a braking system based on a defined brake profile. The brake profile has at least one braking phase with a number of chronologically successive partial braking regions, wherein, within the respective partial braking regions, an actual ego deceleration is defined in such a way that, in the braking phase, the vehicle is braked by an actual ego deceleration that changes over time. The brake profile is defined in the following steps:
detecting road users located in an environment outside the vehicle and detecting passengers located in the interior of the vehicle. Accordingly, persons or living beings inside and outside the vehicle are taken into consideration, with these preferably being detected using environmental signals from an environmental sensor system or using passenger signals from a passenger detection system.
determining road user information which is associated with the respectively detected road users, and determining passenger information which is associated with the respectively detected passengers.
reading in a passenger injury profile for the detected passengers based on the respectively determined passenger information, and reading in a road user injury profile for the detected road users based on the respectively determined road user information. The respective injury profiles indicate (simulated) degrees of injury for the respective passenger or road user, for example based on a so-called Abbreviated Injury Scale (AIS), in order to be able to classify the severity of a possible injury.
defining and/or reading out the brake profile based on the passenger injury profiles read in and/or the road user injury profiles read in, such that there is a minimum degree of injury for the detected road users and/or for the detected passengers in the case of the available brake profiles (BP). The brake profile is thus matched to the persons present or affected, that is to say road users and/or passengers.
outputting the brake profile and actuating the braking system based on the brake profile.

According to the present disclosure, a control unit for carrying out the method and a vehicle, preferably a road vehicle, for example a bus, but also a passenger car, having such a control unit are also provided.

An emergency brake cascade which is usually fixedly parameterized is thus advantageously modified to the effect that the severity of a possible injury is included for all persons or living beings affected by such an emergency braking. The vehicle is therefore not necessarily braked in such a way that it comes to a standstill as far as possible before a determined collision time, but rather in such a way that the smallest possible degree of injury results for all involved persons (inside and outside the vehicle) over the entire emergency braking operation. The braking thus becomes more pleasant for people overall.

To this end, provision is made for the actual ego deceleration of the vehicle and/or an actual jerk of the vehicle in the successive partial braking regions of the braking phase and/or a partial braking interval of the respective partial braking region to be defined based on the passenger injury profile read in and/or the road user injury profile read in, such that there is a minimum degree of injury for the detected road users and/or for the detected passengers. A passenger-friendly and/or road-user-friendly selection of the actual ego deceleration and/or the actual jerk takes place in the individual partial braking regions in order to minimize the degree of injury for the respective persons.

In order to achieve this, provision is made for
the respective passenger injury profile to contain an association between a specific actual ego deceleration of the vehicle and a simulated degree of injury for the respective passenger, and/or
the respective road user injury profile to contain an association between a specific actual ego deceleration of the vehicle and a simulated degree of injury for the respective road user. It is thus advantageously provided, after the detection of the road users and/or passengers, to determine from the respectively associated injury profile the severity with which the injury is expected to occur if the vehicle is braked with a specific actual ego deceleration in the braking phase. Provision is made for
the association between a specific actual ego deceleration of the vehicle and a simulated degree of injury for the respective passenger in the respective passenger injury profile to be determined in advance by simulations and stored, and/or
the association between a specific actual ego deceleration of the vehicle and a simulated degree of injury for the respective road user in the respective road user injury profile to be determined in advance by simulations and stored. Computer simulations in which the respective traffic situation is correspondingly reconstructed are thus carried out beforehand. The severity of the injury can then be derived therefrom, in particular according to the Abbreviated Injury Scale, and this can be used to define the brake profile.

Provision is made for the actual ego deceleration of the vehicle in the successive partial braking regions of the braking phase to be defined such that
a minimum simulated degree of injury is produced for the detected passengers from the passenger injury profile over the entire braking phase and/or
a minimum simulated degree of injury is produced for the detected road users from the road user injury profile over the entire braking phase. The braking phase is thus adjusted in the individual partial braking ranges in such a way that the simulation results in a minimized severity of the injury both for the passengers and for the road users.

It is preferably further provided that
the association of a specific actual ego deceleration of the vehicle with a simulated degree of injury for the respective passenger is included in the passenger injury profile for different passenger characteristics, and/or
the association of a specific actual ego deceleration of the vehicle with a simulated degree of injury for the respective road user is included in the road user injury profile for different road user characteristics. Accordingly, not only is a distinction made between a passenger and a road user, which are each affected by braking of the vehicle in different ways, but a distinction is additionally made between different properties of the passengers and road users.

As a result, differences can additionally be taken into account if
a passenger age and/or passenger gender and/or passenger size included in the determined passenger information are used as passenger characteristics, and/or
a road user age and/or road user gender and/or road user size included in the determined road user information are used as road user characteristics. These properties can have effects on the degree of injury, and so they can be used for a differentiated definition of the brake profile in order to make the braking even more passenger-friendly or road-user-friendly, respectively.

Provision is made, for those detected passengers of the vehicle for whom the respectively determined passenger information reveals that they are seated, for no passenger injury profile to be read in and/or for the brake profile to not be defined based on the passenger injury profile for this seated passenger. As a result, the computational outlay can be minimized since, as a rule, it is not necessary to consider the degree of injury for seated passengers, since they are less at risk in the event of braking and accordingly lower degrees of injury can be assumed for them per se. In an analogous manner, it is also provided for road users who are far away in the environment around the vehicle to be disregarded, these road users generally having no influence on the traffic situation during braking or not being influenced thereby, in order to minimize the computational outlay.

Provision is made for the fact of whether a passenger restraint option is available for the respective passenger to also be determined as passenger information, wherein the simulated degree of injury associated with a passenger for whom there is a passenger restraint option is reduced. Accordingly, it is additionally provided to take into account the fact that the degree of injury of a standing passenger in the case of a specific actual ego deceleration is dependent on whether said passenger also is holding on or can hold on. Accordingly, a lower degree of injury can be assumed.

Provision is made for the brake profile furthermore to include a conditioning phase with a conditioning braking pulse for haptically warning the passengers of the vehicle, wherein the conditioning phase is temporally before the braking phase, wherein the conditioning phase and/or the conditioning braking pulse is also defined based on the passenger injury profile read in and/or the road user injury profile read in such that a minimum degree of injury is produced for the detected road users and/or for the detected passengers. Depending on the estimated collision time, it is thus additionally also provided to provide a haptic warning for the passengers, using which the passengers can be additionally warned so that they can brace themselves for the imminent braking. As a result, the severity of the injury can be additionally reduced, insofar as sufficient time is available, since the passengers can move into an appropriate preparatory position, which then under certain circumstances results in lesser injuries during the braking phase.

Provision is made for a collision time to be determined for the brake profile defined based on the passenger injury profile read in and/or the road user injury profile read in, at which collision time a collision between the vehicle and an identified object in the environment is predicted when the brake profile is used, wherein the brake profile defined based on the passenger injury profile read in and/or the road user injury profile read in is output only when the collision time determined for this is after a collision time which is produced for a brake profile defined without taking into account the passenger injury profile read in and/or the road user injury profile read in. Recourse is thus made to the simulated degrees of injury for the road users or the passengers only if it is possible to determine a brake profile offering better protection than a conventional system with a fixed, invariable emergency braking cascade.

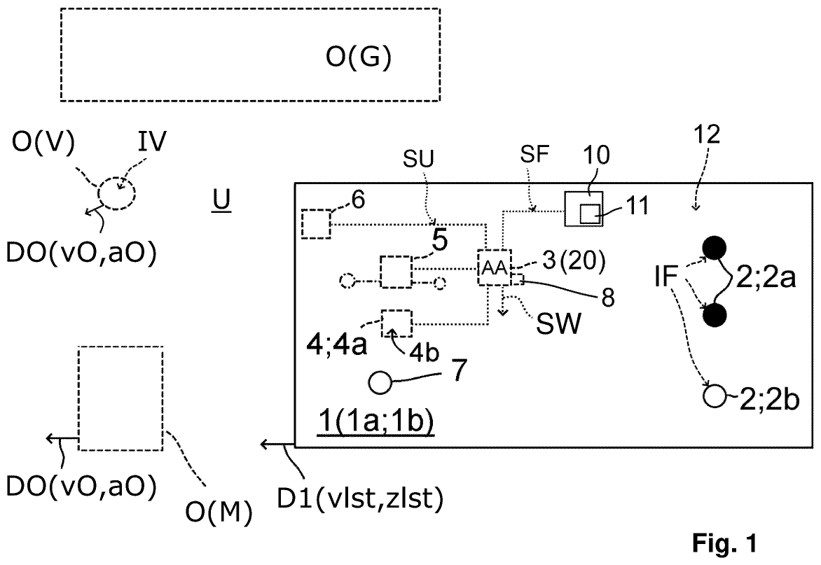

FIG. 1 schematically illustrates a vehicle 1 which serves for transporting or carrying passengers 2, wherein the passengers 2 are passengers 2a who are standing and/or passengers 2b who are not strapped in. The vehicle 1 can be a road vehicle 1a, for example a bus 1b. The vehicle 1 can be a self-driving, autonomously operated vehicle 1 (SAE level 4 or 5) or a manually controlled vehicle 1 (SAE level 3 or lower).

Located in the vehicle 1 is a passenger detection system 10, for example having one or more cameras 11 and/or other sensors, by means of which an interior 12 of the vehicle 1 can be monitored by sensor means. In this case, the passengers 2 are located in the interior 12 and, depending on the autonomy level, a driver 7 is also located there. In particular, the passenger detection system 10 records the passengers 2 and outputs corresponding passenger signals SF for further processing.

The vehicle 1 also has a control unit 3 as a constituent part of an emergency braking system 20 (Advanced Emergency Braking System, AEBS), which control unit is designed to actuate a braking system 4 and/or a transmission 5 of the vehicle 1 within the scope of emergency braking. In this case, any system in the vehicle 1 capable of braking or decelerating the vehicle 1 in a controlled manner can be used as the braking system 4. For this purpose, the braking system 1 can have, for example, friction brakes 4b as braking means, in particular as a constituent part of an (electro)pneumatic braking system 4a, an engine brake, a recuperation brake (utility brake), a retarder, etc.

An environmental sensor system 6 is also provided, by means of which an environment U around the vehicle 1 can be monitored. Objects O, for example external road users V, other means of transport M, buildings G, etc., can be located in the environment U. The environmental sensor system 6 records all these objects O and outputs corresponding environmental signals SU for further processing.

All of the aforementioned objects O represent possible collision objects with which the vehicle 1 can collide. In order to evaluate a collision, the control unit 3 of the emergency braking system 20 can use ego driving dynamics D1 of the vehicle 1, for example an actual ego velocity vIst or an actual ego deceleration zIst, etc. and object dynamics DO resulting from the environmental signals SU, i.e. an object velocity VO or an object acceleration AO, etc., to determine a collision probability W and then generate and output a warning signal SW. At the same time, a collision time TTC (time-to-collision), that is to say a time for a supposed collision with an observed object O if the ego driving dynamics D1 are maintained, can also be precalculated and output by the control unit 3 of the emergency braking system 20.

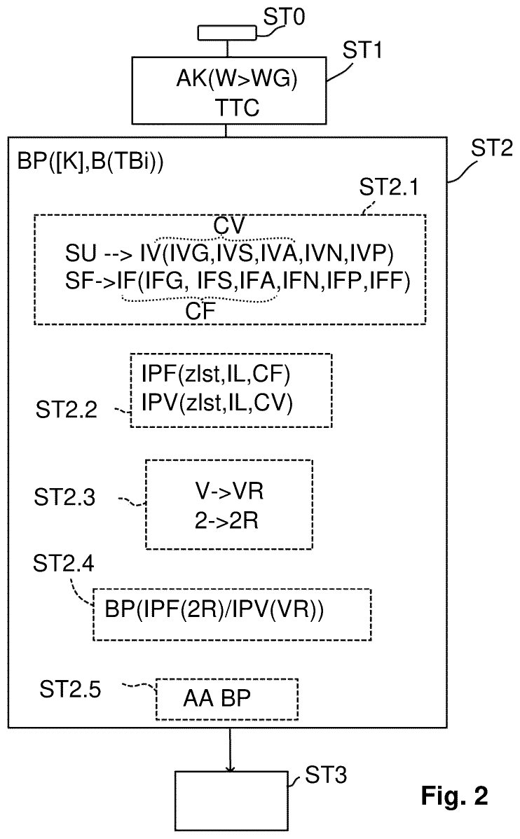

If a trigger criterion AK is met, the control unit 3 is then able to actuate the braking system 4 and/or the drive system 5 in a method illustrated in FIG. 2 in order to implement emergency braking. After an initialization step STO, a first step ST1 first checks whether the trigger criterion AK is met.

The trigger criterion AK can be met, for example, if a warning signal SW, which is automatically generated by the control unit 3 when a limit value WG for the collision probability W is exceeded and in the process indicates a possible collision in the future at the precalculated collision time TTC, is present. In principle, the trigger criterion AK can also be met if the driver 7 of the vehicle 1 manually requests a high setpoint ego deceleration, for example on account of manually initiated braking in order to avoid a collision, and preferably no warning signal SW is present at the same time. However, this merely represents an optional embodiment, since the driver 7 should normally be given full control over the execution of the braking operation.

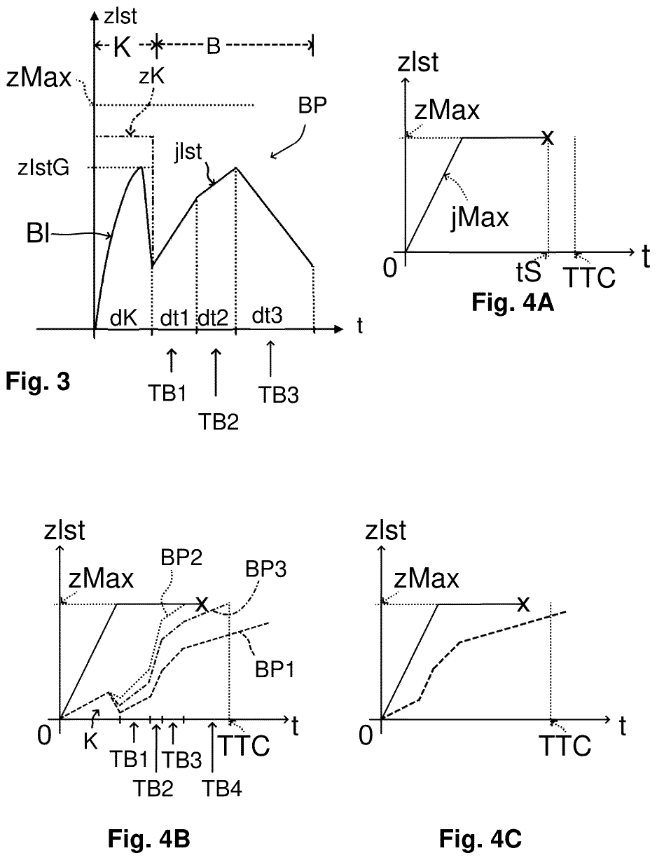

In a subsequent second step ST2, a brake profile BP is selected or defined by the control unit 3. In this case, as illustrated by way of example in FIG. 3, the brake profile BP is generally composed of a conditioning phase K and a subsequent braking phase B. In the conditioning phase K, the vehicle 1 is intended to be braked briefly by a conditioning braking pulse BI. As a result, the passengers 2 of the vehicle 1 are to be conditioned or braced for the subsequent braking of the vehicle 1 in the braking phase B. The conditioning braking pulse BI thus mainly serves for conditioning the passengers 2, who then tense their muscles and possibly also make a lunge in order to increase their stability.

Depending on the precalculated collision time TTC, however, the brake profile BP can also be defined in such a way that the conditioning phase K is omitted in order to be able to bring the vehicle 1 to a standstill in good time and reliably in the subsequent braking phase B. Accordingly, it is possible to establish, based on criteria explained in more detail, that the conditioning of the passengers 2 in the respective emergency braking situation is of lower priority compared to the rapid braking of the vehicle 1 to a standstill.

The conditioning braking pulse BI, if provided, is to be coordinated with respect to time and with respect to intensity in such a way that the passengers 2 can perceive it, but at the same time it is harmless to the passengers 2, that is to say that they do not fall under normal conditions as a result. This can be achieved by the actual ego deceleration zIst of the vehicle 1 at least briefly reaching or exceeding a predefined limiting actual ego deceleration zIstG of at least 1.7 m/s² within a conditioning time period dK (see FIG. 3). This is normally sufficient to achieve a certain perception for the passengers 2 and thus to prepare them for the braking situation.

Since each vehicle 1 triggers a different effect on the passengers 2 depending on the configuration, the limiting actual ego deceleration zIstG must be selected in a vehicle-specific manner. However, in order to prevent the passengers 2 from falling, the limiting actual ego deceleration zIstG during the conditioning phase K must not be selected to be too high, for example between 1 m/s² and approximately 3 m/s².

In the braking phase B, the vehicle 1 is subsequently braked to a standstill, preferably before the collision time TTC, which is precalculated taking into account the braking, has been reached and, in this respect, the braking phase B is not prematurely terminated in a controlled manner in the presence of a termination criterion. The braking phase B is composed of different partial braking ranges TBi, where i=1, 2, 3, . . . N, wherein the number N of partial braking regions TBi can be predefined and is at least two. In FIG. 3, the number N is, for example, three. The respective partial braking regions TBi are extended over time over a certain partial braking interval dti, within which the actual ego deceleration zIst changes with a specific continuous actual jerk jIst (gradient of the actual ego deceleration zIst in the respective partial braking region TBi).

Both the temporal profile of the conditioning phase K with the conditioning braking pulse BI and the temporal profile of the braking phase B with the partial braking ranges TBi are defined after an evaluation of the environmental signals SU, which are output by the environmental sensor system 6, and the passenger signals SF, which are output by the passenger detection system 10. Specifically, according to the present disclosure, provision is made, for the braking of the vehicle 1, for a brake profile PB to be defined for which both the passengers 2 within the vehicle 1 and the road users V outside the vehicle 1 are protected. Such targeted definition of the brake profile BP is intended to minimize the severity of injury to all involved persons both outside and inside the vehicle 1.

In order to be able to protect both the road users V and the passengers 2, corresponding road user information IV, which relates to or characterizes the road users 2 outside the vehicle 1, or passenger information IF, which relates to or characterizes the passengers 2 within the vehicle 1, are initially to be determined from the environmental signals SU and the passenger signals SF in a first intermediate step ST2.1. This can be carried out, for example, by evaluating the respective signals SU, SF using conventional image processing or pattern recognition methods.

A number of passengers IFN and/or a passenger position IFP (standing or not standing) and/or a passenger restraint option IFF (holding bar transverse or longitudinal etc.) and/or a passenger age IFA and/or a passenger gender IFG and/or a passenger size IFS, etc. can for example be determined as passenger information IF by means of corresponding image processing or pattern recognition. In a comparable manner, a number of road users IVN and/or a road user position IVP (standing or driving or sitting) and/or a road user age IVA and/or a road user gender IVG and/or a road user size IVS etc. can be determined as road user information IV using image processing or pattern recognition methods.

This information IF, IV is combined in the control unit 6 of the emergency braking system 20 and a brake profile PB is created therefrom, for example by means of a corresponding selection algorithm AA on the control unit 6. In this case, the selection algorithm AA can create the brake profile PB, for example, from the following aspects:

FIG. 4A illustrates an exemplary time profile of the actual ego deceleration zIst of the vehicle 1, in which the actual ego deceleration zIst increases with a maximum jerk jMax (maximum permissible) up to a maximum deceleration zMax (maximum permissible) and the vehicle 1 is thus braked with the maximum possible braking effect. The maximum deceleration zMax is then maintained (jerk=0) until the vehicle 1 comes to a standstill at a standstill time tS, which is before the calculated collision time TTC. In this case, this time profile of the actual ego deceleration zIst represents an upper limit profile which is defined by the maximum permissible braking dynamics of the vehicle 1. Braking of the vehicle 1 with this time profile would be perceived by the passengers 2 as being very abrupt and strong, and undesired consequential damage can occur under certain circumstances.

In order to increase the comfort and safety for the passengers 2 proceeding from this time profile, the brake profile BP is defined based on the road user information IV and the passenger information IF in such a way that it is below this time profile. In this case, the brake profile BP is not necessarily to be defined in such a way that the standstill time tS is before the precalculated collision time TTC, insofar as the severity of the injury summed over all involved persons (passengers 2/road users V) can thereby be minimized. The brake profile BP is defined here, for example, as follows:

In a second intermediate step ST2.2, a passenger injury profile IPF is read in for each passenger 2 identified in the interior 12 and characterized by the passenger information IF and a road user injury profile IPV is read in for each road user V identified outside the vehicle 1 and characterized by the road user information IV. In the respective injury profile IPF, IPV, an actual ego deceleration zIst is assigned a simulated degree of injury IL. The degree of injury IL is based, for example, on a so-called Abbreviated Injury Scale (AIS). The degree of injury IL or the severity of an injury can be classified according to this Abbreviated Injury Scale with values of “0” (no injury) or “1” (slight injury) to “6” (fatal injury).

Such an assignment can in this case be included in the respective injury profile IPF, IPV for different passenger characteristics CF and for different road user characteristics CV. In this case, the passenger characteristics CF are, for example, the passenger age IFA and/or the passenger gender IFG and/or the passenger size IFS included in the passenger information IF. Accordingly, for example, the road user age IVA and/or the road user gender IVG and/or the road user size IVS are included in the road user information IV as road user characteristics CV.

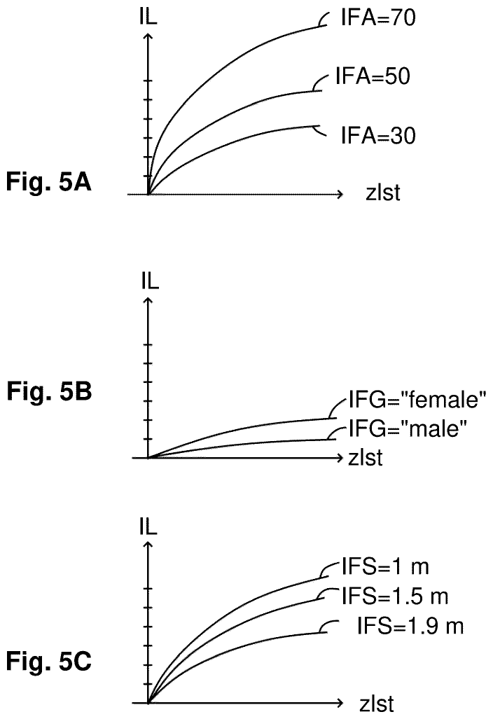

The simulated degree of injury IL is illustrated based on the actual ego deceleration zIst by way of example for the passenger age IFA in FIG. 5A, for the passenger gender IFG in FIG. 5B and for the passenger size IFS in FIG. 5C. The assignment of the simulated degree of injury IL to an actual ego deceleration zIst for a specific passenger characteristic CF or also for a specific road user characteristic CV is determined in advance in simulations. In such a simulation, the reaction of a “virtual passenger”, for whom the respective passenger characteristic CF is applicable, or a “virtual road user”, for whom the respective road user characteristic CV is applicable, is simulated in the event of the vehicle 1 braking with the respective actual ego deceleration zIst, and the resulting potential degree of injury IL is estimated.

The reaction of the “virtual passenger” within the vehicle 1 can be estimated, for example, directly from the strength of the braking of the vehicle 2 and the assumed responsiveness of the respective “virtual passenger”, which results in a corresponding degree of injury IL for the present simulated actual ego deceleration zIst, for example in the event of the “virtual passenger” falling. The reaction of the road users V outside the vehicle 1 can be simulated on the basis of the ego dynamics D1 of the vehicle 1 and the object dynamics DO of the respective road user V. Thus, before the collision time TTC, a relative movement between the two is taken into consideration and the effects of this relative movement on the respective road user V are simulated, which then results in a corresponding degree of injury IL for a specific actual ego deceleration zIst of the vehicle 1.

This degree of injury IL resulting from the simulation is then assigned to the respective actual ego deceleration zIst and the respective passenger characteristic CF or the respective road user characteristic CV, which results in the profiles in FIGS. 5A, 5B, 5C for the passenger 2 and corresponding profiles for a road user V. The profiles simulated in each case for different passenger characteristics CF and for different road user characteristics CV are stored on a memory unit 8, which is located in the control unit 3 or is connected thereto in a signal-conducting manner, for example in the form of an assignment table (look-up table). The selection algorithm AA has continuous access thereto and, in the second intermediate step ST2.2, can read in same as injury profiles IPF, IPV for the respectively identified passengers 2 or road users V.

Subsequently, in a third intermediate step ST2.3, the selection algorithm AA uses the injury profiles IPF, IPV read in to search for a reference passenger 2R from the passengers 2 and to search for a reference road user VR from the road users V. In this case, the reference passenger 2R or the reference road user VR is the one out of all the passengers 2 or road users V involved with the highest simulated degree of injury IL, which is followed by a corresponding comparison from the injury profiles IPF, IPV read in.

Thus, in the profiles in FIGS. 5A, 5B, 5C, for a specific actual ego deceleration zIst, the highest degree of injury IL is always to be expected for a passenger age IFA of 70 years, for a passenger gender IFG of “female” and for a passenger size IFS of “1 m”. Thus, if, for example, the passenger characteristics CF “70 years” and “female” were determined from the passenger information IF for a passenger 2, and passenger characteristics CF which result in lower degrees of injury IL are associated with the other identified passengers 2, this passenger 2 (70 years, female) is sought out as a reference passenger 2R. The same applies to the reference road user VR, who is consequently likewise the most vulnerable road user V.

In this case, in the second intermediate step ST2.2 or in the third intermediate step ST2.3, the individual passengers 2 in the vehicle 1 can either all be checked or compared individually, i.e. a passenger injury profile IPF can be assigned and compared with the other passenger injury profiles IPF, or preferably only passengers 2 with a standing passenger position IFP are taken into account and sitting passengers 2 remain disregarded or their simulated degree of injury IL is reduced accordingly. Furthermore, it is also provided to accordingly reduce the simulated degree of injury IL associated with a passenger 2 for whom a passenger restraint option IFF exists. As a result, it is taken into account that sitting passengers 2 or passengers 2 who can hold on react differently and are potentially less severely injured in the event of a specific actual ego deceleration zIst. In order to save computing time, the seated passengers 2 in particular can be disregarded. Accordingly, this applies to road users V outside the vehicle 1, for example road users V who are far away and who can be disregarded in order to save computing time and computing effort.

In a fourth intermediate step ST2.4, the brake profile BP is then defined in such a way that the least possible severity of injuries results for the sought reference passenger 2R and the sought reference road user VR. This is illustrated below on the basis of FIG. 4B:

In addition to FIG. 4A, a first brake profile BP1 is illustrated therein, which primarily takes into account the passengers 2 in the vehicle 1. In order to define this first brake profile BP1, it is provided, for example, to use the reference passenger 2R with the greatest degree of injury IL, which was determined from the passenger injury profiles IPF in the third intermediate step ST2.3. Based on the passenger injury profile IPF for this reference passenger 2R, the actual ego deceleration zISt and the actual jerk jIst in the conditioning phase K and in the individual partial braking ranges TBi of the braking phase B can be defined such that the overall degree of injury IL is minimal over the entire braking process. The actual ego deceleration zISt and the actual jerk jIst in the individual phases K, B can in this case be selected based on the degree of injury IL, which is assigned to a specific actual ego deceleration zIst in the passenger injury profile IPF.

Injuries in the braking phase B and injuries due to a possible collision are taken into account here. It can therefore be that the vehicle 1 with the selected brake profile BP does not come to a standstill before the collision time TTC, insofar as the severity of the injuries to the passengers 2 is minimized overall. It is thus also taken into account that the passengers 2 are possibly injured to a greater extent by a stronger braking than by a collision at a low residual velocity.

A second brake profile BP2 in FIG. 4B primarily takes into account the road users V, that is to say the vehicle 1 is braked relatively quickly. In order to define this second brake profile BP2, it is provided, for example, to use the reference road user VR with the greatest degree of injury IL, which was determined from the road user injury profiles IPV in the third intermediate step ST2.3. Based on the road user injury profile IPV for this reference road user VR, the actual ego deceleration zIst and the actual jerk jIst in the conditioning phase K and in the individual partial braking ranges TBi of the braking phase B can be defined such that the overall degree of injury IL is minimal over the entire braking process. The actual ego deceleration zIst and the actual jerk jIst in the individual phases K, B can in this case be selected based on the degree of injury IL, which is assigned to a specific actual ego deceleration zISt in the road user injury profile IPV.

In a third brake profile BP3, both preceding brake profiles BP1, BP2 are combined with one another, that is to say both the reference passenger 2R and the reference road user VR with their corresponding injury profiles IPF, IPV are taken into account in the individual phases K, B when defining the actual ego deceleration zIst and the actual jerk jIst. Consequently, the third brake profile BP3 lies between the two other brake profiles BP1, BP2.

The selection algorithm AA then outputs such a defined brake profile BP in a fifth intermediate step ST2.5, so that the latter can subsequently be implemented.

In any brake profiles BP1, BP2, BP3 illustrated in FIG. 4B, a conditioning phase K and a braking phase B with, for example, four partial braking regions TBi are provided, wherein the degrees of injury IL determined by the selection algorithm AA obviously permit or require a conditioning phase K in order to prepare the passengers 2 for braking. Thus, in the examples shown, in view of the collision time TTC and the configuration of the system (passengers 2, road users V, vehicle 1), the conditioning of the passengers 2 is possible and also expedient in order to keep the overall severity of the injury low. If something were to change in the configuration of the system (passengers 2, road users V, vehicle 1) to the effect that, as a result of the conditioning phase K, the subsequent braking phase B becomes too short and, as a result, an excessively high actual ego deceleration zIst is required, which in turn leads to greater degrees of injury IL, the selection algorithm AA can also decide that a brake profile BP without a conditioning phase K and only with a brake phase B (with, for example, four partial braking regions TBi) is created and output, as illustrated by way of example in FIG. 4C. The advantage of conditioning the passengers 2 is thus relinquished in order to reduce the severity of the injuries overall.

The brake profile BP which is output is then used in a third step ST3 in an emergency braking situation, wherein the control unit 3 correspondingly actuates the braking system 4 and/or the transmission 5 in order to implement the brake profile BP and bring the vehicle 1 to a standstill.

In this case, the brake profile BP in the steps described can be determined continuously for different potential collision times TTC or at certain time intervals, for example whenever a change in the configuration or the characteristic of the passengers 2 in the interior 12 has been identified. In this way, it is possible to react quickly to an identified emergency braking situation, since the brake profile BP can be defined in advance and then only has to be read out. Under certain circumstances, however, the brake profile BP can still be adapted during emergency braking, insofar as there are changes with regard to the passengers 2 and/or the road users V.

Should it be identified during the determination of the brake profile BP that no advantageous brake profiles BP can be created by taking into account the road user information IV and the passenger information IF or the respective injury profiles IPF, IPV, it is also provided to revert to a brake profile BP which does not take into account the road user information IV and the passenger information IF or injury profiles IPF, IPV. This brake profile BP is defined in this case by a conventional predefined emergency brake cascade, as is used in a conventional vehicle 1 with a conventional emergency braking system 20.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE SIGNS (PART OF THE DESCRIPTION)

1 Vehicle
1a Road vehicle
1b Bus
2 Passengers
2a Standing passenger
2b Passenger who is not strapped in
2R Reference passenger
3 Control unit
4 Braking system
4a Electropneumatic braking system
4b Friction brake
5 Transmission
6 Environmental sensor system
7 Driver
8 Memory unit
10 Passenger detection system
11 Camera
12 Interior
20 Emergency braking system
AA Selection algorithm
aO Object acceleration
AK Trigger criterion
B Braking phase
BI Conditioning braking pulse
BP Brake profile
BP1 First brake profile
BP2 Second brake profile
BP3 Third brake profile
CF Passenger characteristic
CV Road user characteristic
D1 Ego driving dynamics
DO Object dynamics
dti Partial braking interval
G Building
IF Passenger information
IFA Passenger age
IFF Passenger restraint option
IFG Passenger gender
IFN Number of passengers
IFP Passenger position
IFS Passenger size
IL Degree of injury
IPF Passenger injury profile
IPV Road user injury profile
IV Road user information
IVA Road user age
IVG Road user gender
IVN Number of road users
IVP Road user position
IVS Road user size
jIst Actual jerk
jMax Maximum jerk
K Conditioning phase
M Means of transport
N Number of partial braking regions TBi
O Object
SF Passenger signal
SU Environmental signal
SW Warning signal
TBi i. Partial braking region
tS Standstill time
TTC Collision time
U Environment
V Road user
vIst Actual ego velocity
vO Object velocity
VR Reference road user
W Collision probability
WG Limit value for the collision probability W
zIst Actual ego deceleration
zIstG Limiting actual ego deceleration
zMax Maximum deceleration
ST1, ST2, ST3 Steps of the method
ST2.1, ST2.2, ST2.3, ST2.4, ST2.5 Intermediate steps

1. A method for braking a vehicle with passengers, who are standing and/or not strapped in, in an interior of the vehicle, the method comprising:
in the presence of a trigger criterion, braking the vehicle based on a defined brake profile by a braking system, wherein the brake profile has at least one braking phase with a number of chronologically successive partial braking regions, wherein, within the respective partial braking regions, an actual ego deceleration is defined such that, in the braking phase, the vehicle is braked by the actual ego deceleration, which changes over time, wherein the brake profile is defined in the following steps:
detecting road users located in an environment outside the vehicle and detecting passengers located in the interior of the vehicle,
determining road user information which is associated with the respectively detected road users, and determining passenger information which is associated with the respectively detected passengers;
reading in a passenger injury profile for the detected passengers based on the respectively determined passenger information, and reading in a road user injury profile for the detected road users based on the respectively determined road user information;
defining and/or reading out the brake profile based on the passenger injury profiles read in and/or the road user injury profiles read in, such that there is a minimum degree of injury for the detected road users and/or for the detected passengers in the case of the available brake profiles; and
outputting the brake profile and actuating the braking system based on the brake profile.

2. The method as claimed in claim 1, wherein the actual ego deceleration of the vehicle and/or an actual jerk of the vehicle in the successive partial braking regions of the braking phase and/or a partial braking interval of the respective partial braking region is defined based on the passenger injury profile read in and/or the road user injury profile read in, such that there is a minimum degree of injury for the detected road users and/or for the detected passengers.

3. The method as claimed in claim 2, wherein
the respective passenger injury profile contains an association between a specific actual ego deceleration of the vehicle and a simulated degree of injury for the respective passenger, and/or
the respective road user injury profile contains an association between a specific actual ego deceleration of the vehicle and a simulated degree of injury for the respective road user.

4. The method as claimed in claim 3, wherein the actual ego deceleration of the vehicle in the successive partial braking regions of the braking phase is defined such that:
there is a minimum simulated degree of injury for the detected passengers from the passenger injury profile over the entire braking phase and/or
there is a minimum simulated degree of injury for the detected road users from the road user injury profile over the entire braking phase.

5. The method as claimed in claim 3, wherein:
the association of a specific actual ego deceleration of the vehicle with a simulated degree of injury for the respective passenger is included in the passenger injury profile for different passenger characteristics, and/or
the association of a specific actual ego deceleration of the vehicle with a simulated degree of injury for the respective road user is included in the road user injury profile for different road user characteristics.

6. The method as claimed in claim 5, wherein
a passenger age and/or passenger gender and/or passenger size included in the determined passenger information are used as passenger characteristics, and/or
a road user age and/or road user gender and/or road user size included in the determined road user information are used as road user characteristics.

7. The method as claimed in claim 3, wherein
the association between a specific actual ego deceleration of the vehicle and a simulated degree of injury for the respective passenger in the respective passenger injury profile is determined in advance by simulations and stored, and/or
the association between a specific actual ego deceleration of the vehicle and a simulated degree of injury for the respective road user in the respective road user injury profile is determined in advance by simulations and stored.

8. The method as claimed in claim 3, wherein a fact of whether a passenger restraint option is available for the respective passenger is also determined as passenger information, wherein the simulated degree of injury associated with a passenger for whom there is a passenger restraint option is reduced.

9. The method as claimed in claim 1, wherein, for detected passengers of the vehicle for whom the respectively determined passenger information indicates that the respective passenger is seated, no passenger injury profile is read in and/or the brake profile is not defined based on the passenger injury profile for respective seated passenger.

10. The method as claimed in claim 1, wherein the brake profile furthermore includes a conditioning phase with a conditioning braking pulse for haptically warning the passengers of the vehicle, wherein the conditioning phase is temporally before the braking phase, wherein the conditioning phase and/or the conditioning braking pulse is also defined based on the passenger injury profile read in and/or the road user injury profile read in, such that there is a minimum degree of injury for the detected road users and/or for the detected passengers.

11. The method as claimed in claim 1, wherein a collision time is determined for the brake profile defined based on the passenger injury profile read in and/or the road user injury profile read in, at which collision time a collision between the vehicle and an identified object in the environment is predicted when the brake profile is used, wherein the brake profile defined based on the passenger injury profile read in and/or the road user injury profile read in is output only when the collision time determined for this is after a collision time which is produced for a brake profile defined without taking into account the passenger injury profile read in and/or the road user injury profile read in.

12. The method as claimed in claim 1, wherein the trigger criterion is met based on a determined collision probability of the vehicle with an object being above a predefined limit value.

13. The method as claimed in claim 1, wherein the road users are detected using environmental signals from an environmental sensor system and/or the passengers are detected using passenger signals from a passenger detection system.

14. A control unit for a vehicle for conveying passengers who are standing and/or not strapped in, the control unit configured to carry out the method as claimed in claim 1, wherein, in the presence of a trigger criterion, the control unit is configured to actuate a braking system of the vehicle based on a defined brake profile such that the vehicle can be braked, wherein the brake profile has at least one braking phase with a number of chronologically successive partial braking regions, wherein, within the respective partial braking regions, an actual ego deceleration is defined such a that, in the braking phase, the vehicle can be braked by the actual ego deceleration, which changes over time,
wherein the control unit is configured:
to read in environmental signals from an environmental sensor system and to use the environmental signals to detect road users located in an environment outside the vehicle, and
to read in passenger signals from a passenger detection system and to use the passenger signals to detect passengers located in an interior of the vehicle,
to determine road user information which is associated with the respectively detected road users, and to determine passenger information which is associated with the respectively detected passengers;
to read in a respective passenger injury profile for the detected passengers based on the determined passenger information, and to read in a respective road user injury profile for the detected road users based on the determined road user information;
to define and/or read out the brake profile based on the passenger injury profiles read in and/or the road user injury profiles read in, such that a minimum degree of injury is produced for the detected road users and/or for the detected passengers in the case of the available brake profiles; and
to output the brake profile and to actuate the braking system based on the brake profile which is output.

15. A vehicle for carrying passengers, who are standing and/or not strapped in, in an interior having the control unit as claimed in claim 14, wherein the vehicle is a road vehicle.
